(19) United States
(12) Patent Application Publication
(10) Pub. No.: US 2023/0267559 A1
(43) Pub. Date: Aug. 24, 2023

(54) SYSTEMS AND METHODS FOR A MEETING PLATFORM THAT USES AT LEAST LOCATION-BASED INFORMATION TO FIND MEMBERS

(71) Applicant: Flok Corporation, Imperial Beach, CA (US)

(72) Inventors: Cassia CONNORS, Imperial Beach, CA (US); Jessica Wallace, Imperial Beach, CA (US)

(73) Assignee: Flok Corporation, Imperial Beach, CA (US)

(21) Appl. No.: 18/172,154

(22) Filed: Feb. 21, 2023

Related U.S. Application Data
(60) Provisional application No. 63/312,535, filed on Feb. 22, 2022.

(51) Int. Cl. G06Q 50/00; G06F 3/0482; G06F 3/0484

(52) U.S. Cl. CPC G06Q 50/01; G06F 3/0482; G06F 3/0484

(57) ABSTRACT

In one embodiment, a computer-implemented method is disclosed for managing a meeting platform. The method includes receiving, from a computing device, preferences pertaining to a member of the meeting platform, based on a location of the computing device and the preferences, determining recommended locations for a user of the computing device to check in, receiving a selection of a location from the locations to check in, causing, in a user interface, presentation of members that are checked in at the location, receiving, from the user interface, a selection to meet a member from the one or more members, and initiating a timer for the user and the member to meet at the location.

### CROSS-REFERENCES TO RELATED APPLICATIONS

This application claims priority to and the benefit of U.S. Provisional Application Patent Ser. No. 63/312,535 filed Feb. 22, 2022, the entire disclosure of which is hereby incorporated by reference.

### TECHNICAL FIELD

This disclosure relates to a meeting platform. More specifically, this disclosure relates to systems and methods of for a meeting platform that uses location-based information to find members.

### BACKGROUND

Meeting people of interest is a challenging problem. Especially during times of limited social interaction, such as during a pandemic (e.g., COVID). Even when someone does go out to a restaurant or bar. The person may not be sure someone who meets their interests will be there and also looking to meet. There is a need in the market for a technical solution to this technical problem.

### SUMMARY

In one embodiment, a computer-implemented method for managing a meeting platform is disclosed. The method may include receiving, from a computing device, one or more preferences pertaining to a member of the meeting platform. Based on a location of the computing device and the one or more preferences, the method may include determining one or more recommended locations for a user of the computing device to check in. The method may include receiving a selection of a location from the one or more locations to check in, and causing, in a user interface, presentation of one or more members that are checked in at the location, wherein the one or more members are associated with the meeting platform. The method may include receiving, from the user interface, a selection to meet a member from the one or more members. The method may include initiating a timer for the user and the member to meet at the location.

In one embodiment, a non-transitory, tangible computer-readable medium storing instructions that, when executed, cause a processing device to receive, from a computing device, one or more preferences pertaining to a member of a meeting platform, based on a location of the computing device and the one or more preferences, determine one or more recommended locations for a user of the computing device to check in, receive a selection of a location from the one or more locations to check in, cause, in a user interface, presentation of one or more members that are checked in at the location, wherein the one or more members are associated with the meeting platform, receive, from the user interface, a selection to meet a member from the one or more members, and initiate a timer for the user and the member to meet at the location.

In one embodiment, a system comprises a memory device storing instructions, and a processing device communicatively coupled to the memory device, wherein the processing device executes the instructions to receive, from a computing device, one or more preferences pertaining to a member of a meeting platform, based on a location of the computing device and the one or more preferences, determine one or more recommended locations for a user of the computing device to check in, receive a selection of a location from the one or more locations to check in, cause, in a user interface, presentation of one or more members that are checked in at the location, wherein the one or more members are associated with the meeting platform, receive, from the user interface, a selection to meet a member from the one or more members, and initiate a timer for the user and the member to meet at the location.

Other technical features may be readily apparent to one skilled in the art from the following figures, descriptions, and claims.

### BRIEF DESCRIPTION OF THE DRAWINGS

For a detailed description of example embodiments, reference will now be made to the accompanying drawings in which:

FIG. 1 illustrates a system architecture according to certain embodiments of this disclosure;

FIG. 2 illustrates an example of a method for managing a meeting platform according to certain embodiments of this disclosure;

FIG. 3 illustrates a user interface including a profile configuration screen according to certain embodiments of this disclosure;

FIG. 4 illustrates a user interface including a location check-in screen according to certain embodiments of this disclosure;

FIG. 5 illustrates a user interface including a bird's eye view prompt screen according to certain embodiments of this disclosure;

FIG. 6 illustrates a user interface including a bird's eye view location category selection screen according to certain embodiments of this disclosure;

FIG. 7 illustrates a user interface including a bird's eye view location selection screen according to certain embodiments of this disclosure;

FIG. 8 illustrates a user interface including a member selection screen according to certain embodiments of this disclosure;

FIG. 9 illustrates a user interface including a selected member profile screen according to certain embodiments of this disclosure;

FIG. 10 illustrates a user interface including a connection confirmation screen according to certain embodiments of this disclosure;

FIG. 11 illustrates a user interface including a meeting point coordination screen according to certain embodiments of this disclosure;

FIG. 12 illustrates a user interface including a timer expiration screen according to certain embodiments of this disclosure;

FIG. 13 illustrates an example computer system according to embodiments of this disclosure;

FIG. 14 illustrates a user interface including a missed connection screen according to certain embodiments of this disclosure.

### NOTATION AND NOMENCLATURE

Various terms are used to refer to particular system components. Different entities may refer to a component by different names—this document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection or through an indirect connection via other devices and connections.

The terminology used herein is for the purpose of describing particular example embodiments only, and is not intended to be limiting. As used herein, the singular forms “a,” “an,” and “the” may be intended to include the plural forms as well, unless the context clearly indicates otherwise. The method steps, processes, and operations described herein are not to be construed as necessarily requiring their performance in the particular order discussed or illustrated, unless specifically identified as an order of performance. It is also to be understood that additional or alternative steps may be employed.

The terms first, second, third, etc. may be used herein to describe various elements, components, regions, layers and/or sections; however, these elements, components, regions, layers and/or sections should not be limited by these terms. These terms may be only used to distinguish one element, component, region, layer or section from another region, layer or section. Terms such as “first,” “second,” and other numerical terms, when used herein, do not imply a sequence or order unless clearly indicated by the context. Thus, a first element, component, region, layer or section discussed below could be termed a second element, component, region, layer or section without departing from the teachings of the example embodiments. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. In another example, the phrase “one or more” when used with a list of items means there may be one item or any suitable number of items exceeding one.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), solid state drives (SSDs), flash memory, or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### DETAILED DESCRIPTION

The following discussion is directed to various embodiments of the disclosed subject matter. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

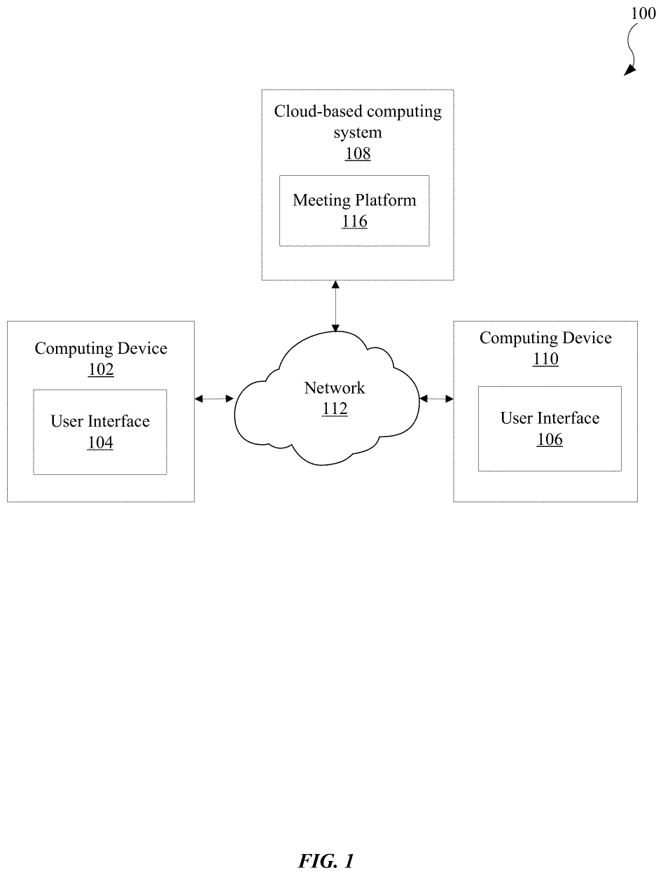

FIGS. 1 through 13, discussed below, and the various embodiments used to describe the principles of this disclosure in this patent document are by way of illustration only and should not be construed in any way to limit the scope of the disclosure.

As described above, meeting a person that matches certain criteria at a desired location may be a technically challenging problem. For example, some conventional applications include selecting people that match certain criteria, but they lack the ability to determine where those people are located in real-time (e.g., less than 2 seconds) or near real-time (e.g., more than 2 seconds but less than 2 minutes), connect with those people, and communicate with those people to set a meeting point.

Accordingly, the present disclosure describes one or more embodiments that may provide one or more technical solutions to the above-described technical problems. For example, the present disclosure relates to a meeting platform that enables members (e.g., users that have registered accounts and/or guests that are temporarily using the meeting platform) to search for other members within a geographical boundary. In some embodiments, the geographical boundary may be a geofence surrounding a computing device (e.g., smartphone) of the member. The geographical boundary may be determined by a global positioning system and/or location services of the computing device. If location services is being used, the computing device may periodically transmit geo-tagged locations of nearby WiFi hotspots and/or cell towers. GPS may be used to receive signals from GPS satellites by the computing device. The signals may include orbital parameters that allow the computing device to decode and compute the precise location of the satellite. The computing device may use this information and/or trilateration to calculate the exact geographical location of the computing device. In some embodiments, a geofence may be established that includes a perimeter of a certain radius around the computing device, and the geofence may be used to identify certain locations where members of the meeting platform have checked in, among other things.

In some embodiments, the meeting platform may provide indications of locations located within a certain perimeter to the computing device, and provide indications of members of the meeting platform that have checked into the locations and that have one or more characteristics that match a preference of the seeking member. For example, the one or more characteristics may include a certain age, gender, preference, relationship status, and the like. If the seeking member finds a checked in member at a certain location, the seeking member may select to meet (also referred to as “Flok” herein) the identified member. If the selected member accepts the meeting invitation, a timer may begin to count for a certain time period and the two members may use a chat application to determine a specific location (e.g., by the bar, by the stairs, outside the front door of the location) to meet. Once the timer has expired, the meeting platform may present an option to continue to Flok for the two members. If one of the two members decides to not continue, that member may be enabled to search for another checked in member at the same location or any other location within a selected geographical region.

The meeting platform may be hosted by a cloud-based computing system. The cloud-based computing system may execute an artificial intelligence engine that uses a training engine to generate one or more machine learning models. The machine learning models may be trained to perform any of the operations of the methods described herein. In some embodiments, the machine learning models may be trained to identify one or more members that are checked in at certain locations that have a higher probability of wanting to meet with the seeking member. In some embodiments, the machine learning models may be trained to provide notifications to the computing device of a member, and the notifications may include suggestions of when the member should search to find other checked in members due to a higher likelihood that the seeking member will find a matched member who wants to Flok.

In some embodiments, the machine learning models may be continuously retrained and/or modified to enhance feature selection of the machine learning models. For example, as updated training data is received and/or user input is provided (e.g., approving or rejecting an output by a machine learning model), the machine learning models may dynamically and automatically change one or more features, such as a number of hidden layers, an activation function, a number of nodes in a layer, a weight applied to an objective function executed by one of the nodes, and the like. The feature selection may be modified to optimize the output of the trained machine learning models.

Turning now to the figures, FIG. 1 depicts a system architecture 10 according to some embodiments. The system architecture 10 may include one or more computing devices 12 of one or more members of a meeting platform 116 communicatively coupled to a cloud-based computing system 108 and/or one or more computing devices 102 and 110. Each of the computing devices 102 and 110, and components included in the cloud-based computing system 108 may include one or more processing devices, memory devices, and/or network interface devices. The network interface devices may enable communication via a wireless protocol for transmitting data over short distances, such as Bluetooth, ZigBee, NFC, etc. Additionally, the network interface devices may enable communicating data over long distances, and in one example, the computing devices 102, the computing device 110, and the cloud-based computing system 108 may communicate with a network 112. Network 112 may be a public network (e.g., connected to the Internet via wired (Ethernet) or wireless (WiFi)), a private network (e.g., a local area network (LAN) or wide area network (WAN)), or a combination thereof. Network 20 may also comprise a node or nodes on the Internet of Things (I).

The computing devices 102 and/or 110 may be any suitable computing device, such as a laptop, tablet, smartphone, or computer. The computing devices 102 and 110 may include a display capable of presenting a user interface 103 and 106, respectively, of the meeting platform 116 hosted by the cloud-based computing system 108. The meeting platform 116 may be implemented in computer instructions stored on the one or more memory devices of the cloud-based computing system 108 and executable by the one or more processing devices of the cloud-based computing system 108. The user interfaces 104 and 106 may present various screens to a user, as descried further below.

In some embodiments, the meeting platform 116 is a stand-alone application installed and executing on the computing devices 104 and 106. In some embodiments, the meeting platform 116 (e.g., website) executes within another application (e.g., web browser). The cloud-based computing system 108 and the computing devices 104 and 106 may also include instructions stored on one or more memory devices that, when executed by the one or more processing devices of the computing devices 104 and 106 perform operations of any of the methods described herein.

In some embodiments, the cloud-based computing system 108 may include one or more servers that form a distributed computing architecture. The servers may be a rackmount server, a router computer, a personal computer, a portable digital assistant, a mobile phone, a laptop computer, a tablet computer, a camera, a video camera, a netbook, a desktop computer, a media center, any other device capable of functioning as a server, or any combination of the above. Each of the servers may include one or more processing devices, memory devices, data storage, and/or network interface cards. The servers may be in communication with one another via any suitable communication protocol.

The servers may execute an artificial intelligence (AI) engine that uses one or more machine learning models to perform at least one of the embodiments disclosed herein. The cloud-based computing system 108 may also include a database that stores data, knowledge, and data structures used to perform various embodiments. For example, the database may store user profiles of members of the meeting platform 116. The database may also store historical information to previous members with which the current member has met with in the past, preferences of the user related to locations for meeting people, statistics around lengths of time the member has met with other members, and the like. In some embodiments, the database may be hosted on one or more of the servers.

In some embodiments the cloud-based computing system 108 may include a training engine capable of generating the one or more machine learning models. The machine learning models may be trained to generate probabilities of members that are checked into certain locations that have a high likelihood of being selected by a seeking member. The machine learning models may also generate notifications of certain times and/or certain locations where the member should look for checked in members to meet with.

For example, the machine learning models may be trained with a corpus of training data including inputs of characteristics of members and characteristics of locations and outputs labeled of probabilities of the user selected those members at those locations based on their characteristics. The labels may be assigned by the user or dynamically determined based on historical usage of the meeting platform 116.

The one or more machine learning models may be generated by the training engine and may be implemented in computer instructions executable by one or more processing devices of the training engine and/or the servers. To generate the one or more machine learning models, the training engine may train the one or more machine learning models 154.

The training engine may be a rackmount server, a router computer, a personal computer, a portable digital assistant, a smartphone, a laptop computer, a tablet computer, a netbook, a desktop computer, an Internet of Things (IoT) device, any other desired computing device, or any combination of the above. The training engine may be cloud-based, be a real-time software platform, include privacy software or protocols, and/or include security software or protocols.

To generate the one or more machine learning models, the training engine may train the one or more machine learning models. The training engine may use a base data set of characteristics of members and/or location, as well as the user's profile, to train the machine learning models to identify likely matches of other users.

The one or more machine learning models may refer to model artifacts created by the training engine using training data that includes training inputs and corresponding target outputs. The training engine may find patterns in the training data wherein such patterns map the training input to the target output and generate the machine learning models that capture these patterns. In some embodiments, the database, and/or the training engine may reside on the cloud-based computing system 108 and/or the computing devices 102 and/or 110.

As described in more detail below, the one or more machine learning models may comprise, e.g., a single level of linear or non-linear operations (e.g., a support vector machine [SVM]) or the machine learning models may be a deep network, i.e., a machine learning model comprising multiple levels of non-linear operations. Examples of deep networks are neural networks, including generative adversarial networks, convolutional neural networks, recurrent neural networks with one or more hidden layers, and fully connected neural networks (e.g., each neuron may transmit its output signal to the input of the remaining neurons, as well as to itself). For example, the machine learning model may include numerous layers and/or hidden layers that perform calculations (e.g., dot products) using various neurons.

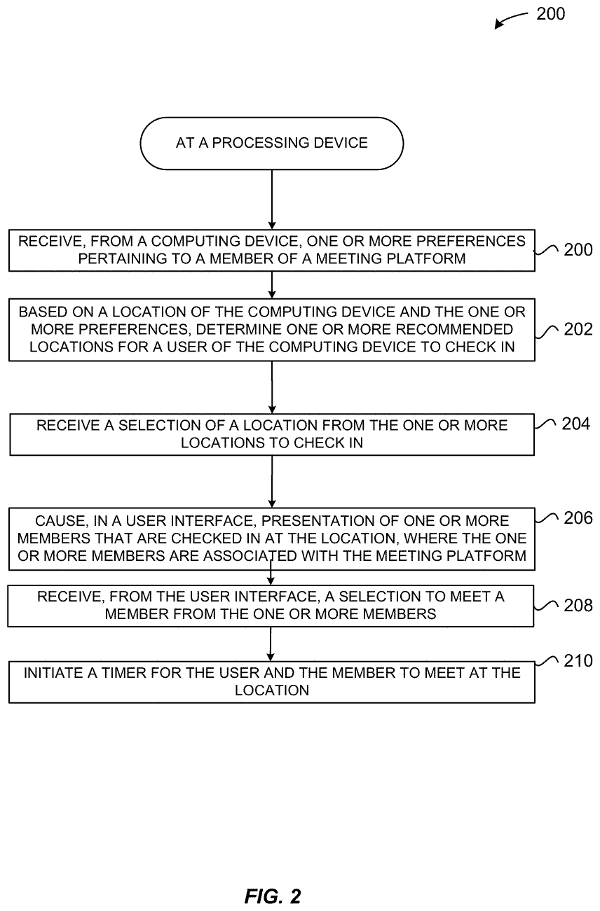

FIG. 2 illustrates an example of a method 200 for managing a meeting platform according to certain embodiments of this disclosure. The method 200 may be performed by processing logic that may include hardware (circuitry, dedicated logic, etc.), software, or a combination of both. The method 200 and/or each of their individual functions, subroutines, or operations may be performed by one or more processors of a computing device (e.g., any component of cloud-based computing system 108, computing device 102, and/or computing device 110 of FIG. 1) implementing the method 200. The method 2400 may be implemented as computer instructions stored on a memory device and executable by the one or more processors. In certain implementations, the method 200 may be performed by a single processing thread. Alternatively, the method 200 may be performed by two or more processing threads, each thread implementing one or more individual functions, routines, subroutines, or operations of the methods.

In some embodiments, one or more machine learning models may be generated and trained by the artificial intelligence engine and/or the training engine to perform one or more of the operations of the methods described herein. For example, to perform the one or more operations, the processing device may execute the one or more machine learning models. In some embodiments, the one or more machine learning models may be iteratively retrained to select different features capable of enabling optimization of output. The features that may be modified may include a number of nodes included in each layer of the machine learning models, an objective function executed at each node, a number of layers, various weights associated with outputs of each node, and the like.

At block 202, the processing device may include receiving, from a computing device, one or more preferences pertaining to a member of meeting platform 116.

At block 204, the processing device may include, based on a location of the computing device and the one or more preferences, determining one or more recommended locations for a user of the computing device to check in.

At block 206, the processing device may include receiving a selection from the one or more locations to check in.

At block 208, the processing device may cause, in a user interface, presentation of one or more members that are checked in at the location. The one or more members may be associated with the meeting platform 116.

At block 210, the processing device may initiate a timer for the user and the member to meet at the location.

In some embodiments, the processing device may present, in the user interface, information pertaining to the one or more locations in an overview display mode (e.g., also referred to as “bird's eye view” herein). The information pertaining to the one or more locations may include a number of members of the meeting platform 116 that are checked in at the one or more locations, one or more geographical positions of the one or more locations, or some combination thereof.

In some embodiments, the processing device may include receiving a selection of whether the user wants to meet the member. Also, responsive to the selection of the location to check in, the processing device may present information pertaining to the user in a list of members that are checked in at the location. In some embodiments, the processing device may connect, via an application programming interface, to one or more social media platforms to obtain information pertaining to the user.

In some embodiments, responsive to the timer expiring, the processing device may present the one or more members associated with the meeting platform 116, and receive a selection of a different member to meet.

In some embodiments, the one or more recommended locations may be determined based on a geofence surrounding the computing device's location. The recommended locations may be determined and/or recommended by one or more trained machine learning models.

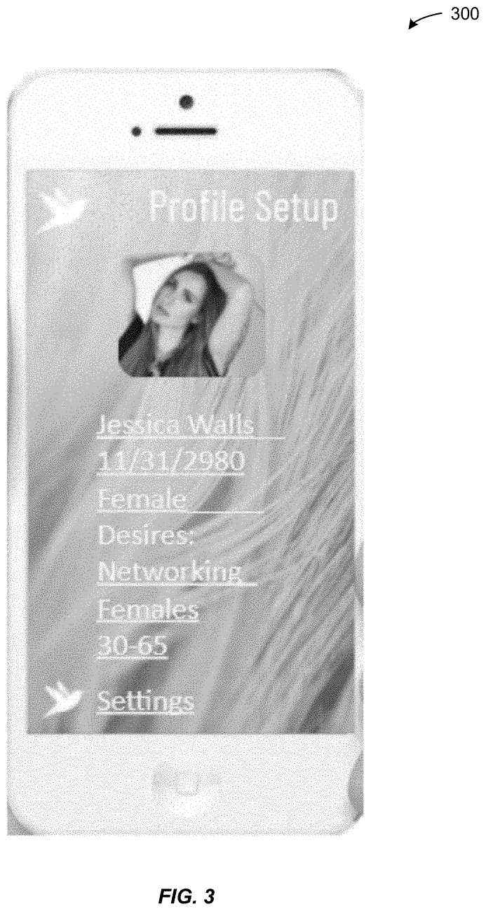

FIG. 3 illustrates a user interface including a profile configuration screen 300 according to certain embodiments of this disclosure. As depicted, a member may configure certain personal information, such as their name, their age, their gender, and their desires. In the depicted example, the member indicated she prefers to network with females aged 0-65.

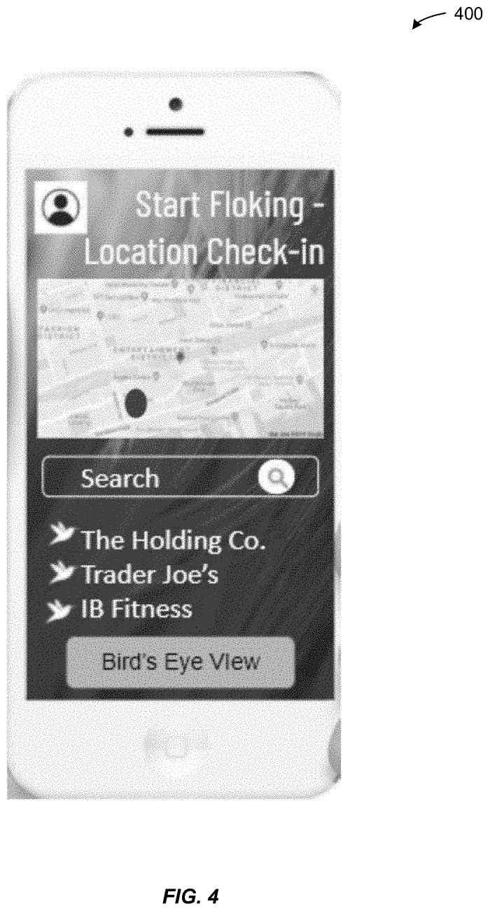

FIG. 4 illustrates a user interface including a location check-in screen 400 according to certain embodiments of this disclosure. As depicted, the location of the computing device of the user has been determined by the meeting platform 116 and locations (e.g., “The Holding Co.”, “Trader's Joe's”, “IB Fitness”) are listed as being within a certain perimeter (e.g., geofence) of the location of the computing device of the user. The screen 400 also includes a graphical element that enables the user to search for other locations that are not identified by the meeting platform 116. The user may use any suitable input peripheral (e.g., mouse, keyboard, microphone, touchpad) to select one of the identified locations. Further, the screen 400 includes a graphical element to choose a “Bird's Eye View” overview display mode.

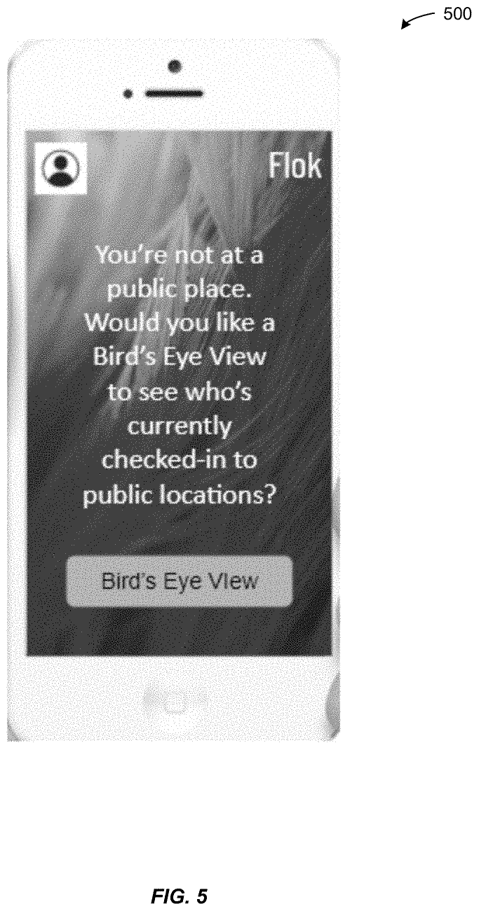

FIG. 5 illustrates a user interface including a bird's eye view prompt screen 500 according to certain embodiments of this disclosure. This screen depicts a prompt that indicates the seeking member is not at a public place and queries whether the seeking member wants a Bird's Eye View to see who is currently checked in to public locations.

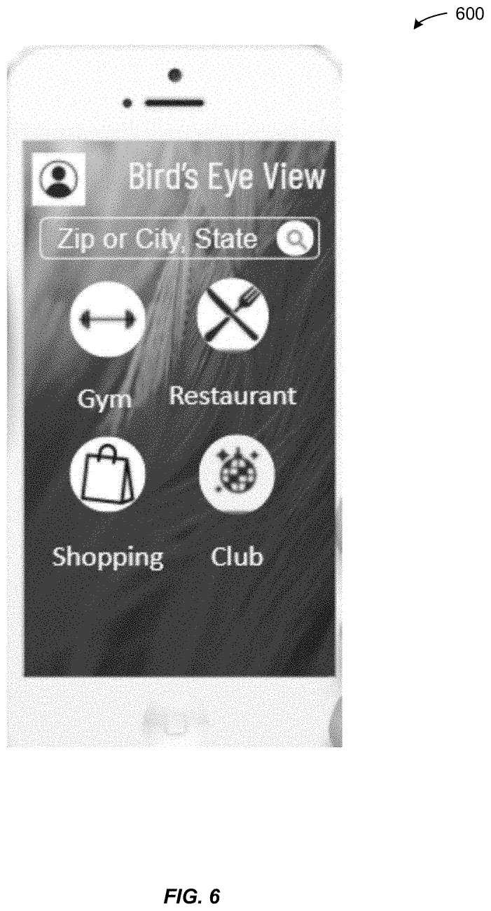

FIG. 6 illustrates a user interface including a bird's eye view location category selection screen 600 according to certain embodiments of this disclosure. As depicted, if the seeking member selects the Bird's Eye View overview display mode, screen 600 is depicted. This screen 600 includes options of various categories of locations for which the seeking member can search for checked-in members to meet.

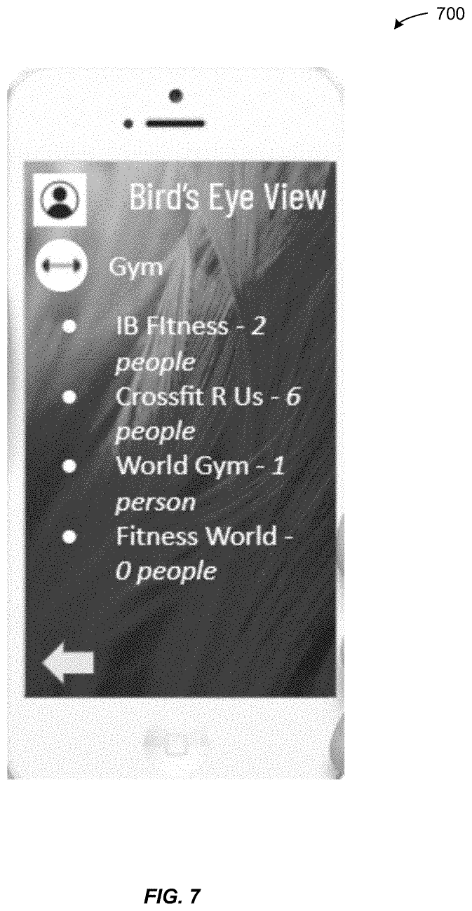

FIG. 7 illustrates a user interface including a bird's eye view location selection screen 700 according to certain embodiments of this disclosure. As depicted in the Bird's Eye View overview display mode, when the seeking member selects the “Gym” category from the screen 600 of FIG. 6, the screen 700 presents more detailed information related to that category. For example, the screen 700 presents several locations (e.g., “IB Fitness”, “Crossfit R Us”, “World Gym”, and “Fitness World”) and the number of members that have checked in to each respective location.

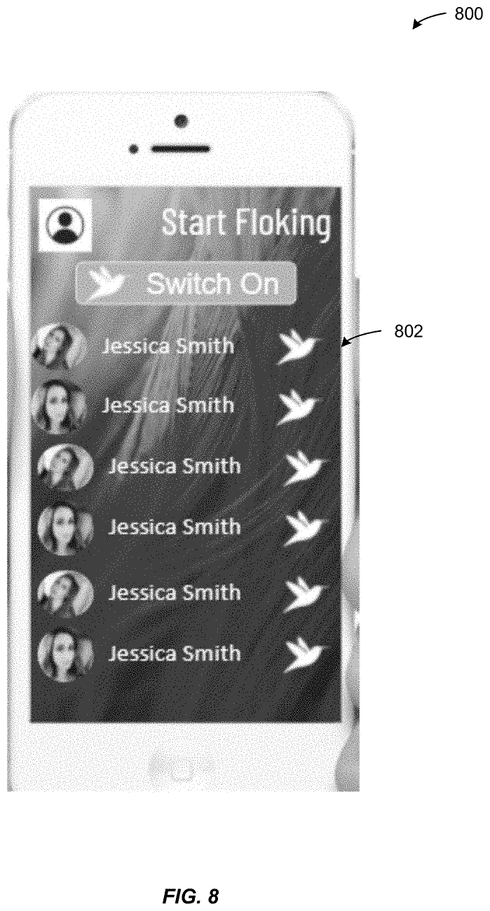

FIG. 8 illustrates a user interface including a member selection screen 800 according to certain embodiments of this disclosure. As depicted, the seeking member selected one of the locations from the screen 700 and is presented with screen 800. Screen 800 includes information pertaining to the members that are checked in at the selected location. The screen also includes a graphical element (e.g., a bird) 802 that is selectable using any suitable input peripheral. The graphical element 802 indicates the member desires to Flok with the selected member who is checked in at the location.

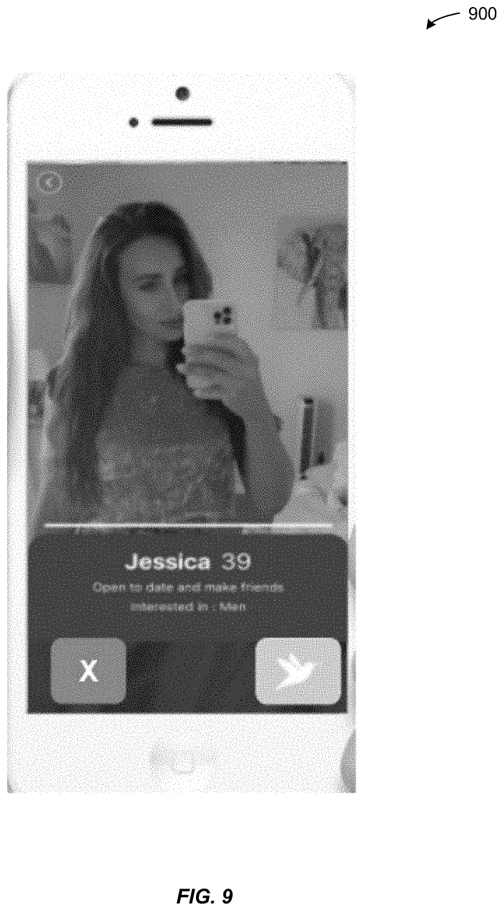

FIG. 9 illustrates a user interface including a selected member profile screen 900 according to certain embodiments of this disclosure. Once the user selects the graphical element 802, a user profile of the selected member may be presented, as depicted in screen 900. The user profile may include information pertaining to the selected member, such as their name, their age, their preferences, their profile picture, and the like. If the seeking member wants to Flok with the selected member, the seeking member may click the graphical elements

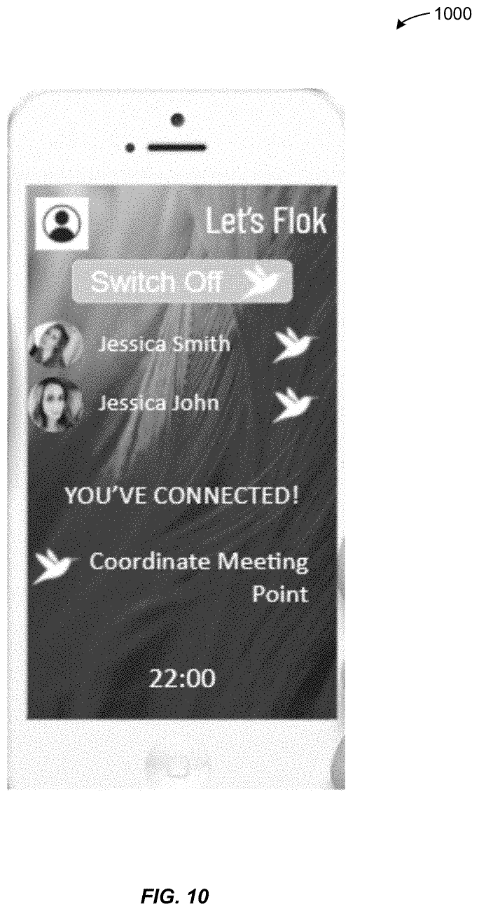

FIG. 10 illustrates a user interface including a connection confirmation screen 1000 according to certain embodiments of this disclosure. When the selected member is chosen to Flok, a computing device of the selected member may present a notification requesting them to confirm whether they want to Flok with the seeking member. If the selected member selects to Flok, then confirmation screen 1000 may be presented on both of the computing devices of the seeking member and the selected member. The screen 1000 may indicate the two members have connected, and may include a graphical element that instructs the two members to coordinate a meeting point. Further, the screen 1000 includes a timer for a certain time limit (e.g., 22 minutes) for the two members to meet.

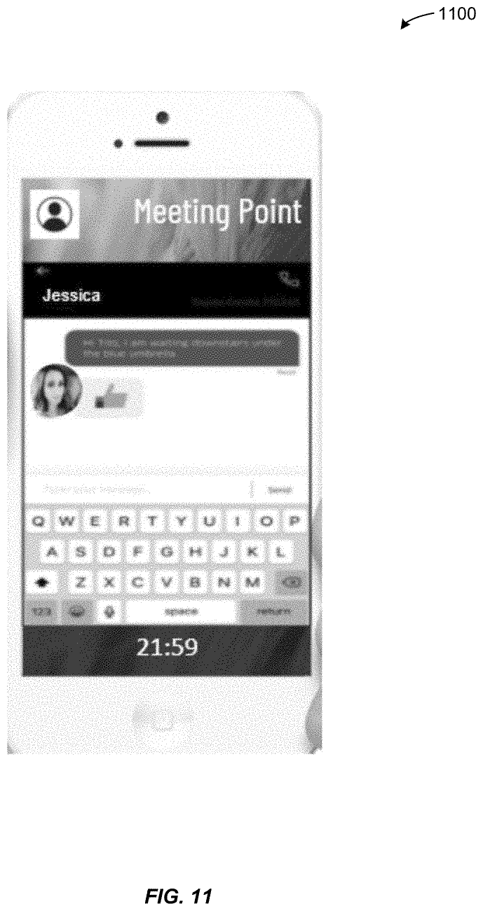

FIG. 11 illustrates a user interface including a meeting point coordination screen 1100 according to certain embodiments of this disclosure. The screen 1100 includes a chat application that enables two-way communication between the computing device of the seeking member and the computing device of the selected member. The chat application enables the two members to transmit text messages, images, and/or voice messages to each other. The two members may use the chat application to coordinate a specific point at which to meet at the location.

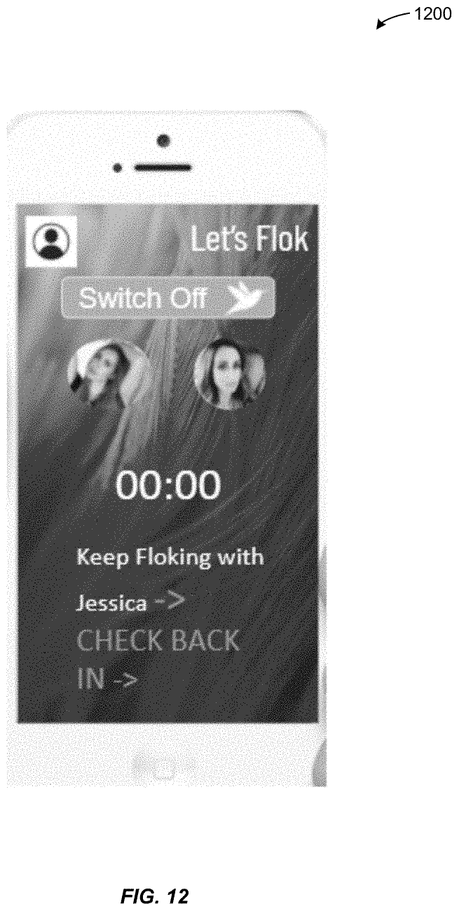

FIG. 12 illustrates a user interface including a timer expiration screen 1200 according to certain embodiments of this disclosure. The screen 1200 depicts that the timer has expired and provides an option for the user to continue to meet with the selected member or to check back in at the location and search for another person to meet with. Such techniques may enable quick networking and getting to know people in specific locations in real-time in a technically enhanced manner. Further, the user interface screens may enhance the user's experience using a computing device and may provide technical improvements.

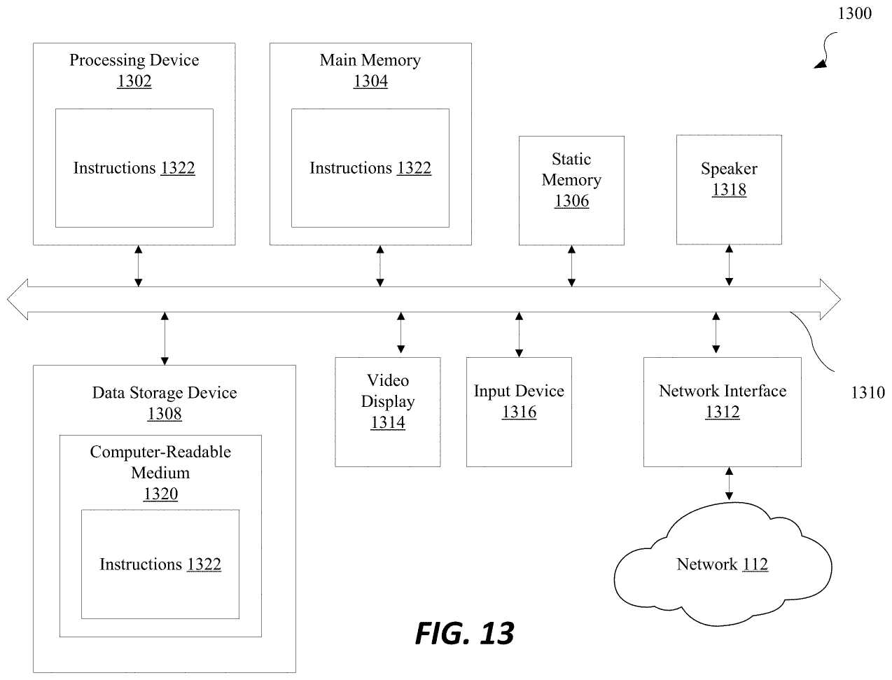

FIG. 13 illustrates an example computer system 1300, which can perform any one or more of the methods described herein. In one example, computer system 1300 may include one or more components that correspond to the computing device 12, computing device 14, one or more servers 128 of the cloud-based computing system 116, or one or more training engines 152 of the cloud-based computing system 116 of FIG. 1. The computer system 1300 may be connected (e.g., networked) to other computer systems in a LAN, an intranet, an extranet, or the Internet. The computer system 1300 may operate in the capacity of a server in a client-server network environment. The computer system 1300 may be a personal computer (PC), a tablet computer, a laptop, a wearable (e.g., wristband), a set-top box (STB), a personal Digital Assistant (PDA), a smartphone, a camera, a video camera, or any device capable of executing a set of instructions (sequential or otherwise) that specify actions to be taken by that device. Further, while only a single computer system is illustrated, the term “computer” shall also be taken to include any collection of computers that individually or jointly execute a set (or multiple sets) of instructions to perform any one or more of the methods discussed herein.

The computer system 1300 includes a processing device 1302, a main memory 1304 (e.g., read-only memory (ROM), solid state drive (SSD), flash memory, dynamic random access memory (DRAM) such as synchronous DRAM (SDRAM)), a static memory 1306 (e.g., solid state drive (SSD), flash memory, static random access memory (SRAM)), and a data storage device 1308, which communicate with each other via a bus 1310.

Processing device 1302 represents one or more general-purpose processing devices such as a microprocessor, central processing unit, or the like. More particularly, the processing device 1302 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 1302 may also be one or more special-purpose processing devices such as an application specific integrated circuit (ASIC), a field programmable gate array (FPGA), a digital signal processor (DSP), network processor, or the like. The processing device 1302 is configured to execute instructions for performing any of the operations and steps of any of the methods discussed herein.

The computer system 1300 may further include a network interface device 1312. The computer system 1300 also may include a video display 1314 (e.g., a liquid crystal display (LCD) or a cathode ray tube (CRT)), one or more input devices 1316 (e.g., a keyboard and/or a mouse), and one or more speakers 1318 (e.g., a speaker). In one illustrative example, the video display 1314 and the input device(s) 1316 may be combined into a single component or device (e.g., an LCD touch screen).

The data storage device 1316 may include a computer-readable medium 1320 on which the instructions 1322 embodying any one or more of the methodologies or functions described herein are stored. The instructions 1322 may also reside, completely or at least partially, within the main memory 1304 and/or within the processing device 1302 during execution thereof by the computer system 1300. As such, the main memory 1304 and the processing device 1302 also constitute computer-readable media. The instructions 1322 may further be transmitted or received over a network 20 via the network interface device 1312.

While the computer-readable storage medium 1320 is shown in the illustrative examples to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

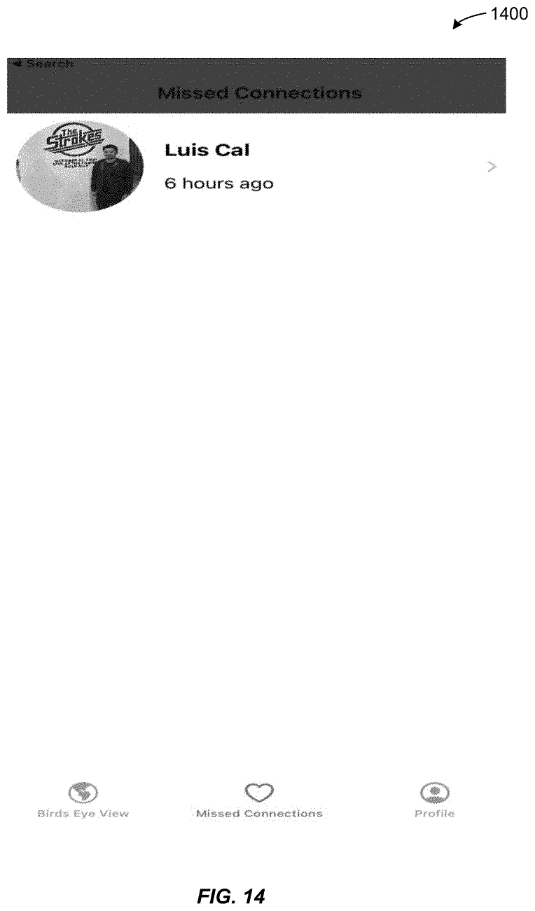

FIG. 14 illustrates a user interface including a missed connections screen 1400 according to certain embodiments of this disclosure. The screen 1400 depicts graphical elements associated with user profiles that the user could have met with at a certain location they were checked in at but did not meet. For example, when a seeking member looks for another member that is checked in at a certain location and does not select to meet with them, the unselected member may appear in the missed connections screen 1400 for a certain time period (e.g., the last 24 hours, the last 48 hours, etc.). The seeking member may select the graphical element associated with the member that they did not connect with, and may select to connect with the member. For example, the seeking member may be enabled to transmit a message directly to the other member via the app or website associated with the meeting platform. In some embodiments, the seeking member may be enabled to share their social media platform information with the other member, and the two members may communicate via the social media platform.

In some embodiments, the seeking member may be enabled, via the meeting platform, to transmit their social media information to a member that they were unable to connect with. In some embodiments, this may be a one-way message, where back-and-forth messaging may be disabled. In other words, the meeting platform may enable an asynchronous message of the seeking member's social media platform information to the missed connection member. Such a technique may enhance the privacy of the seeking member.

In some embodiments, the seeking member may view members of the meeting platform that checked in at locations within a geographical radius to the computing device of the user even when the seeking member was unable to check in at any of the locations. For example, if the seeking member's smartphone ran out of battery and shut off, when the seeking member's smartphone is powered up, the meeting platform may display the user's missed connections for the past 48 hours. Those missed connections may include members that checked in at certain proximate locations while the seeking member's phone was powered off.

In another embodiment, when two members are trying to flok and can't find each other (e.g., in a crowded arena, such as a concert hall), the meeting platform may provide an option to enable the users to drop a pin of their exact location within the meeting place. Dropping a pin may include transmitting exact geographical coordinates of one's computing device to a computing device of the other member. The pin may show up as a graphical element on a map representing the location at which the two members are attending. The graphical element may be placed at the geographical coordinates and a pathway to the pin may be represented on the user interface as a graphical pathway. As the members moves toward each other, the graphical pathway may be shorten and, eventually, disappear, when the members computing devices come within a threshold distance of each other.

The various aspects, embodiments, implementations or features of the described embodiments can be used separately or in any combination. The embodiments disclosed herein are modular in nature and can be used in conjunction with or coupled to other embodiments, including both statically-based and dynamically-based equipment. In addition, the embodiments disclosed herein can employ selected equipment such that they can identify individual users and auto-calibrate threshold multiple-of-body-weight targets, as well as other individualized parameters, for individual users.

The foregoing description, for purposes of explanation, used specific nomenclature to provide a thorough understanding of the described embodiments. However, it should be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It should be apparent to one of ordinary skill in the art that many modifications and variations are possible in view of the above teachings.

The above discussion is meant to be illustrative of the principles and various embodiments of the present disclosure. Numerous variations and modifications will become apparent to those skilled in the art once the above disclosure is fully appreciated. It is intended that the following claims be interpreted to embrace all such variations and modifications.

### CLAUSES

1. A computer-implemented method for managing a meeting platform, the method comprising:
receiving, from a computing device, one or more preferences pertaining to a member of the meeting platform;
based on a location of the computing device and the one or more preferences, determining one or more recommended locations for a user of the computing device to check in;
receiving a selection of a location from the one or more locations to check in;
causing, in a user interface, presentation of one or more members that are checked in at the location, wherein the one or more members are associated with the meeting platform;
receiving, from the user interface, a selection to meet a member from the one or more members; and
initiating a timer for the user and the member to meet at the location.

2. The computer-implemented method of any clause herein, further comprising, responsive to the selection of the member, presenting information pertaining to the member in the user interface, and presenting one or more graphical elements that enable the user to select to meet the member or to not meet the member.

3. The computer-implemented method of any clause herein, further comprising presenting, in the user interface, information pertaining to the one or more locations in an overview display mode, wherein the information pertaining to the one or more locations comprises a number of members of the meeting platform that are checked in at the one or more locations, one or more geographical positions of the one or more locations, or some combination thereof.

4. The computer-implemented method of any clause herein, further comprising receiving a selection of whether the user wants to meet the member.

5. The computer-implemented method of any clause herein, further comprising connecting, via an application programming interface, to one or more social media platforms to obtain information pertaining to the user.

6. The computer-implemented method of any clause herein, further comprising, responsive to the selection of the location to check in, presenting information pertaining to the user in a list of members that are checked in at the location.

7. The computer-implemented method of any clause herein, further comprising:
responsive to the timer expiring, presenting the one or more members associated with the meeting platform; and
receiving a selection of a different member to meet.

8. The computer-implemented method of any clause herein, wherein the one or more recommended locations are determined based on a geofence surrounding the computing device.

9. A non-transitory, tangible computer-readable medium storing instructions that, when executed, cause a processing device to:
receive, from a computing device, one or more preferences pertaining to a member of a meeting platform;
based on a location of the computing device and the one or more preferences, determine one or more recommended locations for a user of the computing device to check in;
receive a selection of a location from the one or more locations to check in;
cause, in a user interface, presentation of one or more members that are checked in at the location, wherein the one or more members are associated with the meeting platform;
receive, from the user interface, a selection to meet a member from the one or more members; and
initiate a timer for the user and the member to meet at the location.

10. The computer-readable medium of any clause herein, further comprising, responsive to the selection of the member, presenting information pertaining to the member in the user interface, and presenting one or more graphical elements that enable the user to select to meet the member or to not meet the member.

11. The computer-readable medium of any clause herein, further comprising presenting, in the user interface, information pertaining to the one or more locations in an overview display mode, wherein the information pertaining to the one or more locations comprises a number of members of the meeting platform that are checked in at the one or more locations, one or more geographical positions of the one or more locations, or some combination thereof.

12. The computer-readable medium of any clause herein, further comprising receiving a selection of whether the user wants to meet the member.

13. The computer-readable medium of any clause herein, further comprising connecting, via an application programming interface, to one or more social media platforms to obtain information pertaining to the user.

14. The computer-readable medium of any clause herein, further comprising, responsive to the selection of the location to check in, presenting information pertaining to the user in a list of members that are checked in at the location.

15. The computer-readable medium of any clause herein, further comprising:
responsive to the timer expiring, presenting the one or more members associated with the meeting platform; and
receiving a selection of a different member to meet.

16. The computer-readable medium of any clause herein, wherein the one or more recommended locations are determined based on a geofence surrounding the computing device.

17. A system, comprising:
a memory device storing instructions; and
a processing device communicatively coupled to the memory device, wherein the processing device executes the instructions to:
receive, from a computing device, one or more preferences pertaining to a member of a meeting platform;
based on a location of the computing device and the one or more preferences, determine one or more recommended locations for a user of the computing device to check in;
receive a selection of a location from the one or more locations to check in;
cause, in a user interface, presentation of one or more members that are checked in at the location, wherein the one or more members are associated with the meeting platform;
receive, from the user interface, a selection to meet a member from the one or more members; and
initiate a timer for the user and the member to meet at the location.

18. The system of any clause herein, further comprising, responsive to the selection of the member, presenting information pertaining to the member in the user interface, and presenting one or more graphical elements that enable the user to select to meet the member or to not meet the member.

19. The system of any clause herein, further comprising presenting, in the user interface, information pertaining to the one or more locations in an overview display mode, wherein the information pertaining to the one or more locations comprises a number of members of the meeting platform that are checked in at the one or more locations, one or more geographical positions of the one or more locations, or some combination thereof.

20. The system of any clause herein, further comprising receiving a selection of whether the user wants to meet the member.

1. A computer-implemented method for managing a meeting platform, the method comprising:
receiving, from a computing device, one or more preferences pertaining to a member of the meeting platform;
based on a location of the computing device and the one or more preferences, determining one or more recommended locations for a user of the computing device to check in;
receiving a selection of a location from the one or more locations to check in;
causing, in a user interface, presentation of one or more members that are checked in at the location, wherein the one or more members are associated with the meeting platform;
receiving, from the user interface, a selection to meet a member from the one or more members; and
initiating a timer for the user and the member to meet at the location.

2. The computer-implemented method of claim 1, further comprising, responsive to the selection of the member, presenting information pertaining to the member in the user interface, and presenting one or more graphical elements that enable the user to select to meet the member or to not meet the member.

3. The computer-implemented method of claim 1, further comprising presenting, in the user interface, information pertaining to the one or more locations in an overview display mode, wherein the information pertaining to the one or more locations comprises a number of members of the meeting platform that are checked in at the one or more locations, one or more geographical positions of the one or more locations, or some combination thereof.

4. The computer-implemented method of claim 1, further comprising receiving a selection of whether the user wants to meet the member.

5. The computer-implemented method of claim 1, further comprising connecting, via an application programming interface, to one or more social media platforms to obtain information pertaining to the user.

6. The computer-implemented method of claim 1, further comprising, responsive to the selection of the location to check in, presenting information pertaining to the user in a list of members that are checked in at the location.

7. The computer-implemented method of claim 1, further comprising:
responsive to the timer expiring, presenting the one or more members associated with the meeting platform; and
receiving a selection of a different member to meet.

8. The computer-implemented method of claim 1, wherein the one or more recommended locations are determined based on a geofence surrounding the computing device.

9. A non-transitory, tangible computer-readable medium storing instructions that, when executed, cause a processing device to:
receive, from a computing device, one or more preferences pertaining to a member of a meeting platform;
based on a location of the computing device and the one or more preferences, determine one or more recommended locations for a user of the computing device to check in;
receive a selection of a location from the one or more locations to check in;
cause, in a user interface, presentation of one or more members that are checked in at the location, wherein the one or more members are associated with the meeting platform;
receive, from the user interface, a selection to meet a member from the one or more members; and
initiate a timer for the user and the member to meet at the location.

10. The computer-readable medium of claim 9, further comprising, responsive to the selection of the member, presenting information pertaining to the member in the user interface, and presenting one or more graphical elements that enable the user to select to meet the member or to not meet the member.

11. The computer-readable medium of claim 9, further comprising presenting, in the user interface, information pertaining to the one or more locations in an overview display mode, wherein the information pertaining to the one or more locations comprises a number of members of the meeting platform that are checked in at the one or more locations, one or more geographical positions of the one or more locations, or some combination thereof.

12. The computer-readable medium of claim 9, further comprising receiving a selection of whether the user wants to meet the member.

13. The computer-readable medium of claim 9, further comprising connecting, via an application programming interface, to one or more social media platforms to obtain information pertaining to the user.

14. The computer-readable medium of claim 9, further comprising, responsive to the selection of the location to check in, presenting information pertaining to the user in a list of members that are checked in at the location.

15. The computer-readable medium of claim 9, further comprising:
responsive to the timer expiring, presenting the one or more members associated with the meeting platform; and
receiving a selection of a different member to meet.

16. The computer-readable medium of claim 9, wherein the one or more recommended locations are determined based on a geofence surrounding the computing device.

17. A system, comprising:
a memory device storing instructions; and
a processing device communicatively coupled to the memory device, wherein the processing device executes the instructions to:
receive, from a computing device, one or more preferences pertaining to a member of a meeting platform;
based on a location of the computing device and the one or more preferences, determine one or more recommended locations for a user of the computing device to check in;
receive a selection of a location from the one or more locations to check in;
cause, in a user interface, presentation of one or more members that are checked in at the location, wherein the one or more members are associated with the meeting platform;
receive, from the user interface, a selection to meet a member from the one or more members; and
initiate a timer for the user and the member to meet at the location.

18. The system of claim 17, further comprising, responsive to the selection of the member, presenting information pertaining to the member in the user interface, and presenting one or more graphical elements that enable the user to select to meet the member or to not meet the member.

19. The system of claim 17, further comprising presenting, in the user interface, information pertaining to the one or more locations in an overview display mode, wherein the information pertaining to the one or more locations comprises a number of members of the meeting platform that are checked in at the one or more locations, one or more geographical positions of the one or more locations, or some combination thereof.

20. The system of claim 17, further comprising receiving a selection of whether the user wants to meet the member.
